(19) United States
(12) Patent Application Publication
(10) Pub. No.: US 2012/0273002 A1
(43) Pub. Date: Nov. 1, 2012

(54) Pipe scraping tool, etc

(76) Inventors: Paul Nicholas Myers, Wakefield (GB); Steven Garfield Farrar, Dewsbury (GB); Gordon Leslie Lilley, Wakefield (GB)

(21) Appl. No.: 13/458,302

(22) Filed: Apr. 27, 2012

(30) Foreign Application Priority Data
Apr. 27, 2011 (GB) 1107030.7

(51) Int. Cl. B08B 9/023; B08B 1/00

(52) U.S. Cl. 134/6; 15/104.04

(57) ABSTRACT

A method of scraping a prescribed area of the external periphery of a synthetic plastics pipe (31) prior to the electro-fusion of a saddle fitting, comprises releasably attaching a scraping device (1), which incorporates a scraping tool (23), to the external periphery (30) of the pipe (31), in a manner that permits movement of the scraping device (1) from a start position around an arc of the pipe (30) in a scraping stroke; and indexing the scraping tool (1) axially along the pipe for repeated arcuate scraping strokes until scraping has been completed over the prescribed area. The invention also includes a pipe scraping device (1) for scraping a prescribed area of the external periphery (30) of a synthetic plastics pipe (31).

This application claims the benefit of British Application Serial No. 1107030.7 filed 27 Apr. 2011.

### FIELD OF THE INVENTION

This invention relates to a method of scraping, skimming or cutting the external periphery of a synthetic plastics pipe—typically of polyethylene—to a shallow depth <0.3 mm, prior to the attachment of a saddle fitting to the convex, external periphery of a pipe by fusion welding.

### BACKGROUND OF THE INVENTION

Synthetic plastics pipes are used extensively by gas and water utilities. Apart from needing end-to-end connection usually by employing a sleeve, into opposite ends of which the ends of the pipes to be joined are inserted prior to fusion welding, there is also a requirement to attach a saddle fitting at a required distribution point for domestic, commercial or industrial premises.

It is well known that the surface of polyethylene pipes deteriorates by oxidation e.g. during outdoor storage, apart from possible damage during transportation and manhandling, and that good fusion welding practice requires the removal by scraping/skimming/cutting (all hereinafter referred to as “scraping”) of a surface layer of the pipe to ensure integrity of the joint and hence avoid premature failure, even after a few years, and attendant costs in remedying the situation.

A rudimentary method of effecting the required scraping is the use of a simple hand tool consisting of a handle and a blade, which hand tool is used after firstly presenting a saddle fitting to the required zone of location on the pipe, then drawing round the perimeter of the fitting with a marker pen, then hatching the area bounded by the perimeter to identify the “patch” to be scraped. It will be appreciated that satisfactory scraping by this technique relies not only on the skill and determination of the operative, but also on accessibility, as a pipe requiring scraping is frequently already located in a trench.

Mechanical scraping devices have been proposed for temporary attachment to a pipe with a view to eliminating the vagaries of hand tool scraping, but a range of pipe diameters require a corresponding range of scraping devices with attendant acquisition, transport and storage costs, and the range of pipe diameters used by gas and water utilities is ever increasing.

### OBJECT OF THE INVENTION

A basic object of the present invention is the provision of an improved method of pipe scraping and pipe scraping device for carrying out the method.

### SUMMARY OF A FIRST ASPECT OF THE INVENTION

According to a first aspect of the invention, there is provided a method of scraping a prescribed area of the external periphery of a synthetic plastics pipe prior to the electro-fusion of a saddle fitting, comprising:
(i) releasably attaching a scraping device, which incorporates a scraping tool, to the external periphery of the pipe, in a manner that permits movement of the scraping device from a start position around an arc of the pipe in a scraping stroke; and
(ii) indexing the scraping tool axially along the pipe for repeated arcuate scraping strokes until scraping has been completed over the prescribed area.

### SUMMARY OF A SECOND ASPECT OF THE INVENTION

According to a second aspect of the invention, there is provided a pipe scraping device for scraping a prescribed area of the external periphery of a synthetic plastics pipe in accordance with the above defined method, comprising:
(i) a scraping tool;
(ii) means to releasably attach the scraping device to a pipe such that the scraping device is rotatable, over an arc, with respect to the pipe to displace the scraping tool arcuately about the pipe in a scraping stroke;
(iii) means to index the scraping tool with respect to the scraping device, and in an axial direction along the pipe, whereby repeated arcuate scraping strokes complete the scraping over the prescribed area.

### ADVANTAGES OF THE INVENTION

The invention provides a method and apparatus whereby a pipe scraping device can be used for a range of pipe diameters, the skill required for hand tool scraping is eliminated, and scraping to correct depth over the entire prescribed “patch” area can be ensured.

### PREFERRED OR OPTIONAL FEATURES OF THE FIRST ASPECT OF THE INVENTION

A scraping stroke in a first direction, is followed by an idle stroke in a return direction to the start position, which is followed by indexing, ready for the next scraping stroke.

A scraping stroke in a first direction, is followed by indexing, which is followed by a scraping stroke in a return direction, which is followed by indexing.

The scraping device is manually displaced in the first direction and in the second, return direction.

The indexing of the scraping tool is effected manually.

The indexing of the scraping tool is effected by a drive transmission.

### PREFERRED OR OPTIONAL FEATURES OF THE SECOND ASPECT OF THE INVENTION

The scraping device comprises a pair of spaced-apart parallel frame members each having first and second ends.

At least one tie member connects the frame members together.

Two parallel tie members connect the frame members together.

The or each tie member is rotatable.

The or each tie member is non-rotatable.

At least one flexible banding means is connectable by one of its ends to a first end of one frame member and adapted, after being wrapped around the pipe, to be connected by its other end to a second end of the same frame member to secure the scraping device to the pipe.

Two flexible banding means are employed, one associated with each frame member.

The, or each, flexible banding means is a chain.

The, or each, chain incorporates rollers to engage the pipe.

The, or each, flexible banding means is a metallic or non-metallic band.

One end of each flexible banding means is attachable to one portion of each frame member, whilst the other end of each flexible banding means are releasably attached to a screw adjustable block for final tightening of the scraping device around the pipe.

An indexing spindle extends parallel to the or each tie member.

Means is provided to rotate the indexing spindle in one direction through a predetermined arc.

A carriage is mounted on, and engages, the indexing spindle and carries the scraping tool, the carriage being axially advanceable along the indexing spindle from the vicinity of one frame member towards the other frame member, upon rotation of the indexing spindle, in accordance with the length of the patch to be scraped.

The scraping tool is in the form of a knife or blade with a cutting tip or edge.

The frame members are generally “L”-shaped beams profiled from plate.

The scraping device is provided with a plurality of pipe engaging wheels.

Four pipe engaging wheels are provided.

One of the four wheels is rotatably mounted at each end of the two, parallel tie members.

If the tie members are rotatable, they constitute spindles to which the pipe engaging wheels are fixed.

If the tie members are non-rotatable, the pipe engaging wheels are rotatably mounted on the tie members.

At least one wheel has a ribbed, knurled, or otherwise interrupted contact surface to aid gripping of the scraping device on the pipe.

Means are provided to pre-set the maximum wheel rotation, and hence the arc of the patch to be scraped.

The means to set the maximum wheel rotation and hence the circumferential movement of the scraping device and hence its scraping tool comprises an arcuate groove cut into and partially around, a side face of at least one wheel engageable by an adjustable pin, so that the opposed ends of the groove act as abutment stops.

A groove is cut into two pin-engageable wheels on the same tie rod or axle, so that the device is usable by a left-handed or right-handed operative.

The indexing rod is externally threaded, in which case the carriage is provided with a nut.

The indexing rod is provided with an external helical groove, in which case the carriage is provided with an engagement pin.

The external thread or groove of the indexing spindle is of suitable pitch to ensure traverse over a sufficient axial “patch” length of the pipe, upon rotation of the indexing spindle.

In an embodiment of scraping device suitable for a range of smaller diameter pipes, two parallel tie members are provided.

The means to rotate the indexing spindle is a handgrip.

The handgrip serves to rotate the indexing spindle via a one way clutch.

The handgrip is co-axial with the indexing spindle.

The handgrip is located at an opposite side of one of the frame members to the indexing spindle.

A second handgrip, also co-axial with the indexing spindle, is located at an opposite side of the other frame member.

Each handgrip is mounted on an extension of the indexing spindle.

The indexing, by the one handgrip, is through 90°.

The other handgrip is freely rotatable on its extension.

In an embodiment of scraper device suitable for a range of larger diameter pipes the two spaced-apart frame members are secured together by multiple, parallel non-rotatable tie rods, which also serve as hand grips for displacing the scraper device in its arcuate, scraping direction, and its arcuate, return direction.

This embodiment is also provided with two parallel axles, each carrying a pair of coaxial, spaced-apart pipe-engaging wheels, the axles being rotatable in bearings carried by the frame member.

The pipe scraping device incorporates a drive transmission to index the scraping tool, constituted by an endless toothed belt extending between a smaller diameter driven toothed pulley connected to one of the pipe-engaging wheels, or its support spindle, and a larger diameter, driven toothed pulley carried by the indexing rod e.g. to provide 4:1 reduction.

The carriage incorporates a cartridge or holder for the scraping tool.

The scraping tool is replaceable and is mounted at one end of the holder.

The scraping tool has a shoulder to control, or assist in controlling, the depth of cut.

The cartridge or holder is spring loaded in the carriage.

The carriage includes an extension piece slidably engageable with one of the ties to prevent carriage rotation upon rotation of the indexing spindle.

The extension piece engages one of the ties by having a through hole of diameter slightly exceeding that of a tie, whereby the tie passes through the hole and the extension piece slides along the tie during indexing.

The carriage is provided with a nut for adjustment of the scraping “height” of a cutting tip of the scraping tool.

### BRIEF DESCRIPTION OF THE DRAWINGS

The invention will now be described in greater detail by way of example with reference to the accompanying drawings, in which:

FIG. 1 is a perspective view of a first embodiment of pipe scraping device in accordance with the second aspect of the invention, for effecting the method of the first aspect of the invention, on a range of smaller diameter pipes;

FIG. 2 is a side elevation of the device of FIG. 1;

FIG. 3 is an end elevation of FIG. 2; and

FIG. 4 is a perspective view of a second embodiment of pipe scraping device in accordance with the second aspect of the invention, for effecting the method of the first aspect of the invention, on a range of larger diameter pipes.

### DETAILED DESCRIPTION OF THE DRAWINGS

In both embodiments, like components are accorded like reference numerals.

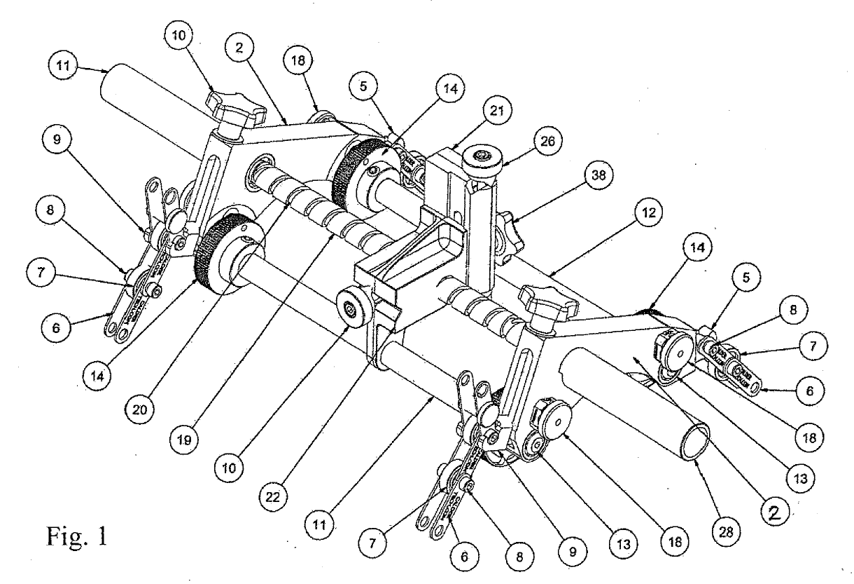

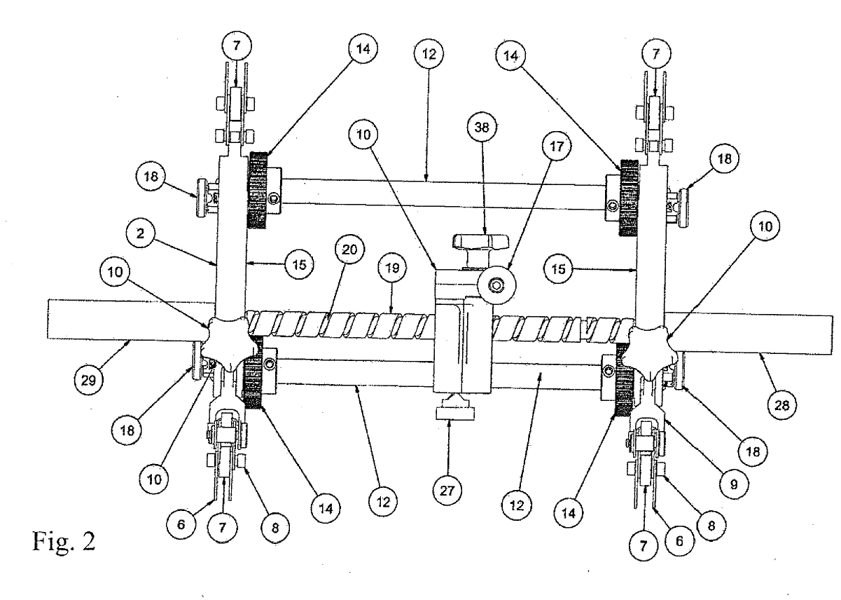

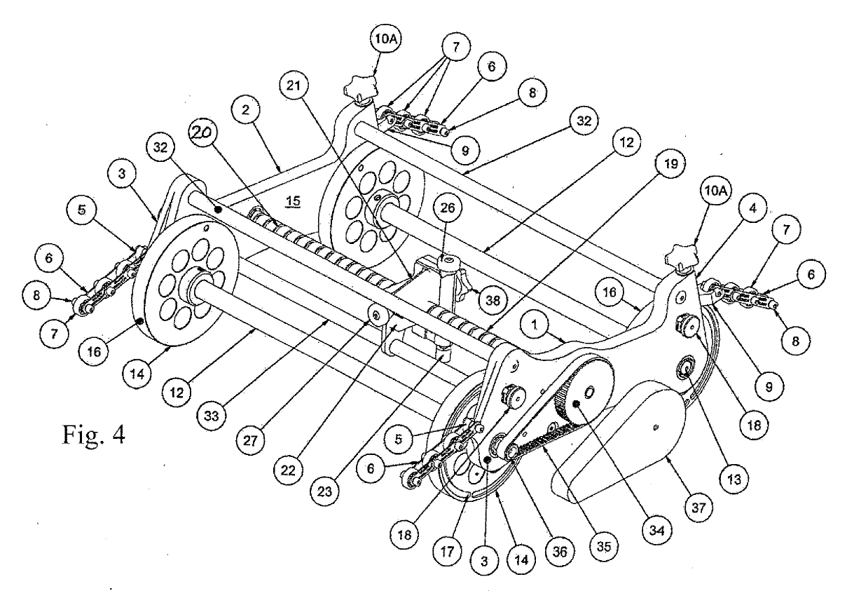

A pipe scraping device 1 comprises a pair of spaced-apart, parallel frame members 2 in the form of beams profiled from plate, each having a first end 3 and a second end 4. One end 5 of a link chain 6 is releasably attached to the first end 3 of each frame member 2, the links of the chains 6 carrying a plurality of rollers 7. The frame members 2 are spaced-apart by a distance slightly exceeding the maximum “length” of patch that the device 1 is designed to scrape, in the axial direction of the pipe involved. The other end 8 of each link chain 6 is releasably engageable in a fitting 9 at the second end 4 of each frame member 2, which fitting 9 is provided with screw device 10 for manual tightening of the chains 6. In the embodiment of FIGS. 1 to 3, final tightening, if required, is effected by an Allen Key engaging a socket 11 in each screw device 10. In the embodiment of FIG. 4, final tightening is effected by a hand wheel 10A.

The frame members 2 are secured together in their spaced-apart relationship by a pair of parallel tie members 12. Ends of the tie members 12 are rotatably supported in bearings 13 mounted in the frame member 2, such that the tie members 12 constitute axles, on each of which are mounted, a pair of pipe engaging wheels 14, one adjacent the inside surface 15 of each frame member 2, and each wheel 14 is provided with a knurled contact surface 16 to aid gripping of the pipe.

In the embodiment of FIGS. 1 to 3, two of the wheels 14 are provided, in one side face, with an arcuate groove 17 engageable by a stroke length setting plunger operable by a thumbscrew 18, whilst in the embodiment of FIG. 4, all four wheels 14 are grooved.

An indexing spindle 19, constituting a feed screw. and having an external helical groove 20, also extends between the frame members 2, parallel to the tie members 12.

Mounted on the indexing spindle 19 is a carriage 21 with an internal drive pin (not shown) engaging the groove 20, and with and extension piece 22 slidably engaging one of the tie members 12, in the embodiment of FIGS. 1 to 3.

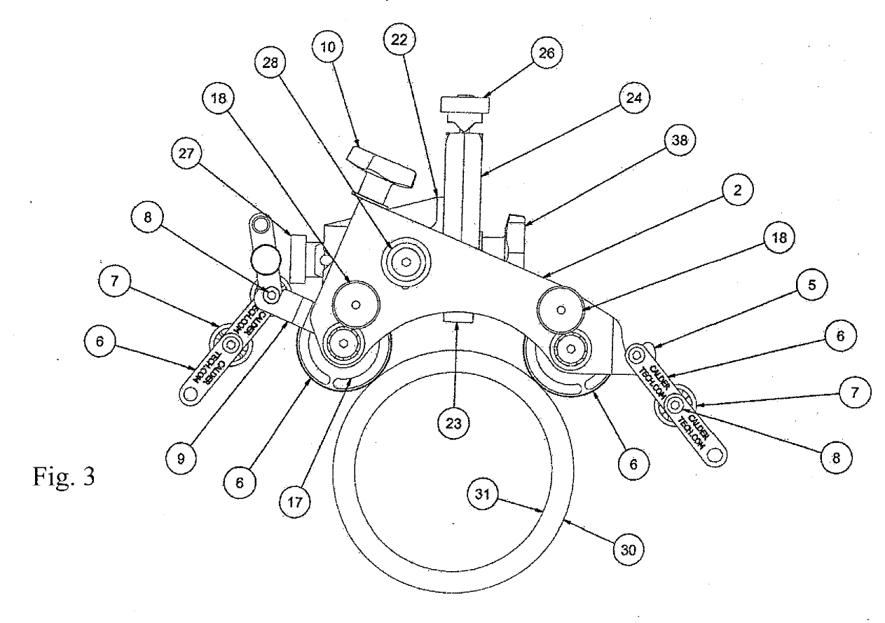

The carriage 21 also comprises a scraping with a tool 23 (FIG. 3), a spring-loaded cartridge 24, a tip height adjustment nut 25, and tip lifting thumbscrews 26, a feed screw drive control thumb screw 27, and a top cartridge height adjustment hand wheel 38.

In the embodiment of FIGS. 1 to 3, indexing of the spindle 19 is effected by rotating a (right hand) handgrip 28 through 90° for which purpose the indexing spindle 19 is extended through each frame member 2, with the handgrip 28 drivably fixed to one extension, whilst a (left hand) handgrip 29 is rotatably mounted on its extension.

The method of use of the first embodiment of pipe scraping device 1 is indicated in FIG. 3.

The carriage 21 needs to be positioned, by rotation of the handle 28 at the end of the indexing spindle 19 adjacent the handle 29, either before the pipe scraping device 1 has been presented to a pipe to be scraped or after the pipe scraping device 1 has been attached to the pipe to be scraped, by engaging the four knurled wheels 14 with arcuate external periphery 30 of a pipe 31 in the zone where a “patch”, usually of rectangular profile, of dimensions suitable for the (industry-standard) saddle fitting that is required to be fusion-welded to the pipe 31, is required to be scraped. In the first embodiment of pipe scraping device 1, the ends 5 of each link chain 6 are permanently attached to the first end 3 of its frame member 2, the chains 6 are wrapped around the pipe 31, so that the other chain end 8 may be engaged in the fitting 9 and the screw device 10 tightened to secure the scraping device 1, for manual displacement, over a prescribed arc, by the operator pushing (or pulling) the pipe scraping device 1 in a first, scraping direction, over the arcuate external periphery 30 of the pipe 31, the arc being determined by the setting of the pins in the grooves 17, with the tool 23 engaging the periphery 30 of the pipe. Upon completion of the scraping arc, the operative displaces the scraping device 1 in the second, return direction. The operator then rotates the handgrip 28 through 90° to rotate the indexing spindle 19 through 90°, which in turn axially advances the carriage 21, ready for a repeat of arcuate movement in the first, scarping direction, with the carriage 21 progressively being indexed along the spindle 19 towards the handle 28.

The scraping, return, and indexing sequence is repeated, until a patch of required surface area for the saddle fitting required to be fused to the external periphery 30 of the pipe 31 has been completed.

In the embodiment of FIG. 4, for a range of larger diameter pipes 31, the indexing spindle extensions to carry the handgrips 28 and 29 of the first embodiment are omitted, and the operator pushes, or pulls, on a pair of fixed tie rods 32 extending between the two frame members 2. In this embodiment, a third fixed tie rod 33 is provided, along which the extension piece 22 of the carriage 21 is slidable.

In this embodiment, the indexing spindle 19 extends through one frame member 2 and carries a larger diameter, 48 tooth driven toothed pulley 34 around which is wrapped an endless toothed belt 35, extending to a smaller diameter, 12 tooth drive toothed pulley 36 attached to one of the tie members or axles 12, with a one-way clutch, such that in the scraping stroke, the belt drive is ineffective, but during the return stroke is effective to automatically index the spindle 19 ready for the next scraping stroke. Also indicated at 37 is a drive guard.

After completion of the patch, the chain ends 8 are released from the fittings 9, so that the scraping device 1 may be removed from the pipe and fusion-welding of the saddle may be effected.

It will be appreciated that the lengths of the chains 6 enable a range of pipe diameters to be accommodated by the same pipe scraping device 1. However, for ranges of larger pipe diameters, the embodiment of FIG. 4 is more suitable.

1-45. (canceled)

46. A method of scraping a prescribed area of the external periphery of a synthetic plastics pipe prior to the electro-fusion of a saddle fitting, comprising:
(i) releasably attaching a scraping device, which incorporates a scraping tool, to the external periphery of the pipe, in a manner that permits movement of the scraping device from a start position around an arc of the pipe in a scraping stroke; and
(ii) indexing the scraping tool axially along the pipe for repeated arcuate scraping strokes until scraping has been completed over the prescribed area.

47. A method as claimed in claim 46, wherein a scraping stroke in a first direction, is followed by an idle stroke in a return direction to the start position, which is followed by indexing, ready for the next scraping stroke.

48. A method as claimed in claim 46, wherein a scraping stroke in a first direction, is followed by indexing, which is followed by a scraping stroke in a return direction, which is followed by indexing.

49. A method as claimed in claim 46, wherein the pipe scraping device is manually displaced in both a first direction and in a second, return direction.

50. A pipe scraping device for scraping a prescribed area of the external periphery of a synthetic plastics pipe, comprising:
(i) a scraping tool;
(ii) means to releasably attach the scraping device to a pipe such that the scraping device is rotatable, over an arc, with respect to the pipe to displace the scraping tool arcuately about the pipe in a scraping stroke;
(iii) means to index the scraping tool with respect to the scraping device, and in an axial direction along the pipe, whereby repeated arcuate scraping strokes complete the scraping over the prescribed area.

51. A pipe scraping device as claimed in claim 50, comprising a pair of spaced-apart, parallel frame members each having first and second ends, with two parallel tie members connecting the frame members.

52. A pipe scraping device as claimed claim 51, wherein the means to releasably attach the scraping device to a pipe comprises at least one flexible element connectable by one of its ends to the first end of one frame member and adapted, after being wrapped around the pipe, to be connected by its other end to the second end of the same frame member.

53. A pipe scraping device as claimed in claim 50, provided with four pipe engaging wheels.

54. A pipe scraping device as claimed in claim 51, provided with an indexing spindle extending parallel to the tie members.

55. A pipe scraping device as claimed in claim 54, provided with means to rotate the indexing spindle in one direction through a predetermined arc.

56. A pipe scraping device as claimed in claim 55, provided with a carriage mounted on, and engaging, the indexable spindle and carrying the scraping tool, the carriage being axially advanceable along the indexing spindle, upon rotation of the indexing spindle.

57. A pipe scraping device as claimed in claim 52, wherein two flexible elements are provided, one associated with each frame member, with each flexible element constituted by a chain incorporating rollers to engage the pipe.

58. A pipe scraping device as claimed in claim 57, wherein one end of each flexible element is attachable to one portion of each frame member, whilst the other “free” ends of each flexible element are releasably attached to a screw adjustable block for final tightening of the scraping device around the pipe.

59. A pipe scraping device as claimed in claim 53, wherein means are provided to pre-set the maximum wheel rotation, and hence the arc of the prescribed patch area to be scraped.

60. A pipe scraping device as claimed in claim 59, wherein the means to set the maximum wheel rotation comprises an arcuate groove cut into and partially around, a side face of at least one wheel engageable by an adjustable pin.

61. A pipe scraping device as claimed in claim 54, wherein the means to rotate the indexing spindle is a handgrip coaxial with the indexing spindle.

62. A pipe scraping device as claimed in claim 54, wherein a freely rotatable second handgrip, coaxial with the indexing spindle, is located at one side of the pipe scraping device with the indexing spindle handgrip located at an opposite side of the pipe scraping device.

63. A pipe scraping device as claimed in claim 51, wherein the two spaced-apart frame members are secured together by multiple, parallel non-rotatable tie rods, which also serve as handgrips for arcuate displacement of the scraping device.

64. A pipe scraping device as claimed in claim 63, incorporating a drive transmission to index the scraping tool, constituted by an endless toothed belt extending between a smaller diameter driven toothed pulley connected to a pipe-engaging wheel, or a support spindle thereof, and a larger diameter, driven toothed pulley carried by an indexing spindle.

65. A pipe scraping device as claimed in claim 56, wherein the carriage includes an extension piece slidably engageable with a tie rod.
